(19) United States
(12) Patent Application Publication
(10) Pub. No.: US 2024/0326460 A1
(43) Pub. Date: Oct. 3, 2024

(54) PRINTING DEVICE AND PRINTING METHOD

(71) Applicant: SEIKO EPSON CORPORATION, Tokyo (JP)

(72) Inventor: Kenji OTOKITA, YAMAGATA-MURA (JP)

(21) Appl. No.: 18/614,873

(22) Filed: Mar. 25, 2024

(30) Foreign Application Priority Data
Mar. 28, 2023 (JP) 2023-051110

(51) Int. Cl. B41J 2/21; B41J 2/145; B41J 11/00; B41J 25/00; C09D 11/101

(52) U.S. Cl. CPC B41J 2/2107; B41J 2/145; B41J 11/00214; B41J 25/001; C09D 11/101

(57) ABSTRACT

A printing device includes a head unit; a movement section configured to relative movement of the print medium and the head unit; an irradiation sections of ultraviolet rays; and a storage section, wherein it has, as nozzle rows, a first nozzle row which ejects the first ink of the first color and a second nozzle row which ejects the second ink of the first color having different characteristics from the first ink, the storage section is configured to store a plurality of print modes in which having different ratios between the print duty of the first ink and the print duty of the second ink, and when print data includes first color data to be printed using ultraviolet curable ink of the first color, it is configured to distribute into the first ink and the second ink based on the ratio of a selected print mode and then print.

The present application is based on, and claims priority from JP Application Serial Number 2023-051110, filed Mar. 28, 2023, the disclosure of which is hereby incorporated by reference herein in its entirety.

### BACKGROUND

### 1. Technical Field

The present disclosure relates to a printing device and a printing method.

### 2. Related Art

In the related art, various printing devices that perform printing by ejecting ink to a print medium are used. Among these, there is a printing device that forms a printed product by ejecting ultraviolet curable ink to a print medium. The printed product formed using the ultraviolet curable ink is used in a variety of applications, such as labels for bottles and outdoor signs. Then, the characteristics required for the printed product change according to the use. The characteristics of the printed product vary greatly depending on the type of ultraviolet curable ink used. Here, JP-A-2022-107267, for example, discloses a radiation curable inkjet composition in which the flexibility of a coating film and adhesiveness to the print medium is improved in order to suppress cracking of the coating film formed on the printed product.

The radiation curable inkjet composition disclosed in JP-A-2022-107267 has excellent in flexibility of the coating film and adhesiveness to the print medium. Therefore, it is suitable for use as a label for a bottle which is used by expanding and contracting the printed product. On the other hand, in outdoor sign applications and the like, abrasion resistance, weather resistance, and the like are more required than flexibility of the coating film, adhesiveness to the print medium, and the like. In addition, there is a case where it is required to form the printed product using an ultraviolet curable ink which is more excellent in abrasion resistance, weather resistance, and the like than the radiation curable inkjet composition disclosed in JP-A-2022-107267. As described above, in the printing device which forms the printed product by ejecting the ultraviolet curable ink to the print medium in the related art, it is difficult to form the printed product according to the use using ultraviolet curable ink.

### SUMMARY

A printing device according to the present disclosure for solving the above problem includes a head unit that has nozzle rows in which a plurality of nozzles are arranged and that is configured to eject an ultraviolet curable ink to a print medium from the nozzles based on print data; a movement section configured to cause relative movement of the print medium and the head unit; an irradiation section configured to irradiate ultraviolet rays to cure the ultraviolet curable ink that was ejected from the nozzle and that landed on the print medium; an operation section; a storage section; and a control section, wherein the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink, the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row, the control section is configured to enable selection of at least one selected print mode from among the plurality of print modes via the operation section, and the control section is configured to, when the print data includes first color data to be printed using the ultraviolet curable ink of the first color, distribute the first color data into the first ink and the second ink based on the ratio of the selected print mode and then print.

A printing method for a printing device according to the present disclosure for solving the above problem, the printing device including a head unit that has nozzle rows in which a plurality of nozzles are arranged and that is configured to eject an ultraviolet curable ink to a print medium from the nozzles based on print data; a movement section configured to cause relative movement of the print medium and the head unit; an irradiation section configured to irradiate ultraviolet rays to cure the ultraviolet curable ink that was ejected from the nozzle and that landed on the print medium; an operation section; and a storage section, wherein the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink, the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row, and the control section is configured to enable selection of at least one selected print mode from among the plurality of print modes via the operation section, the method includes when the print data includes first color data to be printed using the ultraviolet curable ink of the first color, the first color data is distributed into the first ink and the second ink based on the ratio of the selected print mode and then printed.

### BRIEF DESCRIPTION OF THE DRAWINGS

FIG. 1 is a schematic side view of a printing device according to a first embodiment of the present disclosure.

FIG. 2 is a schematic bottom view showing a head unit of the printing device according to the first embodiment of the present disclosure.

FIG. 3 is a drawing showing a specific example of how the first ink and the second ink are distributed to the print data of one pixel using the printing device according to the first embodiment of the present disclosure.

FIG. 4 is a schematic side view of the printing device according to a second embodiment of the present disclosure.

FIG. 5 is a schematic side view of the printing device according to a third embodiment and a fourth embodiment of the present disclosure.

FIG. 6 is a schematic bottom view showing the head unit of the printing device according to the third embodiment of the present disclosure.

FIG. 7 is a schematic bottom view showing the head unit of the printing device according to the fourth embodiment of the present disclosure.

FIG. 8 is a schematic side view of the printing device according to a fifth embodiment and a sixth embodiment of the present disclosure.

FIG. 9 is a schematic bottom view shoeing the head unit of the printing device according to the fifth embodiment of the present disclosure.

FIG. 10 is a schematic bottom view showing the head unit of the printing device according to the sixth embodiment of the present disclosure.

### DESCRIPTION OF EMBODIMENTS

First, the present disclosure will be schematically described.

A printing device according to a first aspect of the present disclosure for solving the above problem includes a head unit that has nozzle rows in which a plurality of nozzles are arranged and that is configured to eject an ultraviolet curable ink to a print medium from the nozzles based on print data; a movement section configured to cause relative movement of the print medium and the head unit; an irradiation section configured to irradiate ultraviolet rays to cure the ultraviolet curable ink that was ejected from the nozzle and that landed on the print medium; an operation section; a storage section; and a control section, wherein the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink, the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row, the control section is configured to enable selection of at least one selected print mode from among the plurality of print modes via the operation section, and the control section is configured to, when the print data includes first color data to be printed using the ultraviolet curable ink of the first color, distribute the first color data into the first ink and the second ink based on the ratio of the selected print mode and then print.

According to the present aspect, since the selected print mode can be selected according to the use, it is possible to form the printed product using the first ink and the second ink which have the same color and different characteristics at a preferable ratio as the ultraviolet curable ink. Therefore, it is possible to form the printed product according to the application by using the ultraviolet curable ink.

A second aspect of the printing device according to the present disclosure is an aspect dependent on the first aspect, wherein the control section is configured to enable selection of a plurality of selected print modes via the operation section and when a plurality of selected print modes are selected, the control section averages the ratios of the selected print modes, and when the print data includes the first color data to be printed using the ultraviolet curable ink of the first color, the control section distributes the first color data into the first ink and the second ink based on the averaged average ratio and then prints.

According to the present aspect, it is possible to select the plurality of selected print modes, and when the plurality of selected print modes are selected, it averages the ratios of each selected print mode, and it is configured to distribute the first color data into the first ink and the second ink based on the averaged average ratio and then print. Therefore, for example, when there are a plurality of preferential characteristics, it is possible to form the printed product under a condition finely optimized corresponding to various applications.

A third aspect of the printing device according to the present disclosure is an aspect dependent on the first or second aspect, wherein the first nozzle row is disposed such that the first ink is ejected to the print medium before the second ink when printing is performed using the ultraviolet curable ink of the first color with respect to the second nozzle row and the first ink has higher wettability with respect to the print medium than the second ink.

According to the present aspect, the first ink is ejected to the print medium earlier than the second ink, and the wettability of the first ink with respect to the print medium is higher than the second ink. By depositing the first ink, which has higher wettability, to the print medium before the second ink, the adhesiveness of the coating film formed on the printed product, the solid uniformity of the coating film, and the like are improved. Therefore, it is possible to form the printed product suitable for a wide range of applications.

A fourth aspect of the printing device according to the present disclosure is an aspect dependent on the third aspect, wherein the irradiation section includes an actual curing section configured to perform actual curing by irradiating the ultraviolet curable ink that was ejected from the nozzles and that landed on the print medium with ultraviolet rays, and a temporary curing section configured to perform temporary curing with a lower curing degree than the actual curing by irradiating the ultraviolet curable ink that was ejected from the nozzles and that landed on the print medium with ultraviolet rays, each of the nozzle rows is formed such that the plurality of nozzles are arranged in a width direction that intersects a relative movement direction of the print medium and the head unit, and when printing is performed using the ultraviolet curable ink of the first color, the first nozzle row, the first temporary curing section as the temporary curing section, the second nozzle row, and the second temporary curing section as the temporary curing section are disposed in this order, which is the order in which the print medium faces them in the relative movement direction.

According to the present aspect, it is possible to use a so-called line head having the nozzle row in which the plurality of nozzles are arranged in the width direction to temporarily cure the first ink by the first temporary curing section immediately after the first ink is ejected to the print medium from the first nozzle row and to temporarily cure the ultraviolet curable ink by the second temporary curing section immediately after the second ink is ejected to the print medium from the second nozzle row. According to such a configuration, it is possible to suppress a decrease in printing quality of a thin line or the like due to excessive spreading of the ultraviolet curable ink on the print medium due to a delay in temporary curing.

A fifth aspect of the printing device according to the present disclosure is an aspect dependent on the third aspect, wherein the irradiation section includes an actual curing section configured to perform actual curing by irradiating the ultraviolet curable ink that was ejected from the nozzles and that landed on the print medium with ultraviolet rays, and a temporary curing section configured to perform temporary curing with a lower curing degree than the actual curing by irradiating the ultraviolet curable ink that was ejected from the nozzles and that landed on the print medium with ultraviolet rays, each of the nozzle rows is formed such that the plurality of nozzles are arranged in a width direction that intersects a relative movement direction of the print medium and the head unit, and when printing is performed using the ultraviolet curable ink of the first color, the first nozzle row, the second nozzle row, and the temporary curing section are disposed in this order, which is the order in which the print medium faces them in the relative movement direction.

According to the present aspect, it is possible to use the so-called line head having the nozzle row in which the plurality of nozzles are arranged in the width direction to temporarily cure the ultraviolet curable ink by the temporary curing section after ejecting the first ink to the print medium from the first nozzle row and further ejecting the second ink to the print medium from the second nozzle row. With such a configuration, it is possible to suppress a decrease in the solid uniformity of the coating film due to the ultraviolet curable ink being temporarily cured before sufficiently spreading on the print medium due to the timing of the temporary curing being too early.

A sixth aspect of the printing device according to the present disclosure is an aspect dependent on the third aspect, wherein the irradiation section includes an actual curing section configured to perform actual curing by irradiating the ultraviolet curable ink that was ejected from the nozzle and that landed on the print medium with ultraviolet rays, each of the nozzle rows is formed such that the plurality of nozzles are arranged in a width direction that intersects a relative movement direction of the print medium and the head unit, and when printing is performed using the ultraviolet curable ink of the first color, the first nozzle row, the second nozzle row, and the actual curing section are disposed in this order, which is the order in which the print medium faces them in the relative movement direction.

According to the present aspect, it is possible to use the so-called line head having the nozzle row in which the plurality of nozzles are arranged in the width direction to actually cure the ultraviolet curable ink in the actual curing section after ejecting the first ink to the print medium from the first nozzle row and further ejecting the second ink to the print medium from the second nozzle row. With such a configuration, it is possible to simplify the device configuration, and it is possible to suppress a decrease in the solid uniformity of the coating film due to the ultraviolet curable ink being actual curing before sufficiently spreading on the print medium.

A seventh aspect of the printing device according to the present disclosure is an aspect dependent on the third aspect, wherein the head unit is configured to reciprocally move in a width direction that intersects a relative movement direction of the print medium and the head unit, each of the nozzle rows is formed with the plurality of nozzles that are arranged along the relative movement direction, the first nozzle row and the second nozzle row are arranged in series in the relative movement direction, and the irradiation section, the first nozzle row and the second nozzle row, and the irradiation section are disposed in order from one side to the other side in the width direction.

According to the present aspect, it is possible to eject the first ink from the first nozzle row to the print medium and then to cure the ultraviolet curable ink by the irradiation section, and then to relative movement the print medium and the head unit relative to each other to change the pass, and further to eject the second ink from the second nozzle row to the print medium and then to cure the ultraviolet curable ink by the irradiation section by using a so-called serial head having the nozzle row in which the plurality of nozzles are arranged along the relative movement direction and capable of reciprocating movement in the width direction, for each reciprocating movement of the head unit. With such a configuration, it is possible to reduce the number of nozzle rows to be formed and it is possible to miniaturize the head unit. It is possible to suppress a decrease in printing quality of a thin line or the like due to excessive spreading of the ultraviolet curable ink on the print medium due to a delay in irradiation of ultraviolet rays.

A eighth aspect of the printing device according to the present disclosure is an aspect dependent on the third aspect, wherein the head unit is configured to reciprocally move in a width direction that intersects a relative movement direction of the print medium and the head unit, each of the nozzle rows is formed with the plurality of nozzles that are arranged along the relative movement direction, the first nozzle row and the second nozzle row are arranged in parallel in the width direction, and the irradiation section, the first nozzle row, the second nozzle row, the second nozzle row, the first nozzle row, and the irradiation section are disposed in order from one side to the other side in the width direction.

According to the present aspect, it is possible to eject the first ink from the first nozzle row to the print medium and eject the second ink from the second nozzle row to the print medium for each reciprocating movement of the head unit, and then the ultraviolet curable ink can be cured by the irradiation section by using the so-called serial head which has the nozzle row in which the plurality of nozzles are arranged along the relative movement direction and can reciprocating movement in the width direction. With such a configuration, it is possible to increase the printing speed, and it is possible to suppress a decrease in printing quality of a thin line or the like a spread of the ultraviolet curable ink to the print medium due to the delay of the irradiation of the ultraviolet rays.

A printing method of ninth aspect of the present disclosure, the printing device including a head unit that has nozzle rows in which a plurality of nozzles are arranged and that is configured to eject an ultraviolet curable ink to a print medium from the nozzles based on print data; a movement section configured to cause relative movement of the print medium and the head unit; an irradiation section configured to irradiate ultraviolet rays to cure the ultraviolet curable ink that was ejected from the nozzle and that landed on the print medium; an operation section; and a storage section, wherein the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink, the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row, and the control section is configured to enable selection of at least one selected print mode from among the plurality of print modes via the operation section, the method includes when the print data includes first color data to be printed using the ultraviolet curable ink of the first color, the first color data is distributed into the first ink and the second ink based on the ratio of the selected print mode and then printed.

According to the present aspect, since the selected print mode can be selected according to the use, it is possible to form the printed product using the first ink and the second ink which have the same color and different characteristics at a preferable ratio as the ultraviolet curable ink. Therefore, it is possible to form the printed product according to the application by using the ultraviolet curable ink.

### First Embodiment

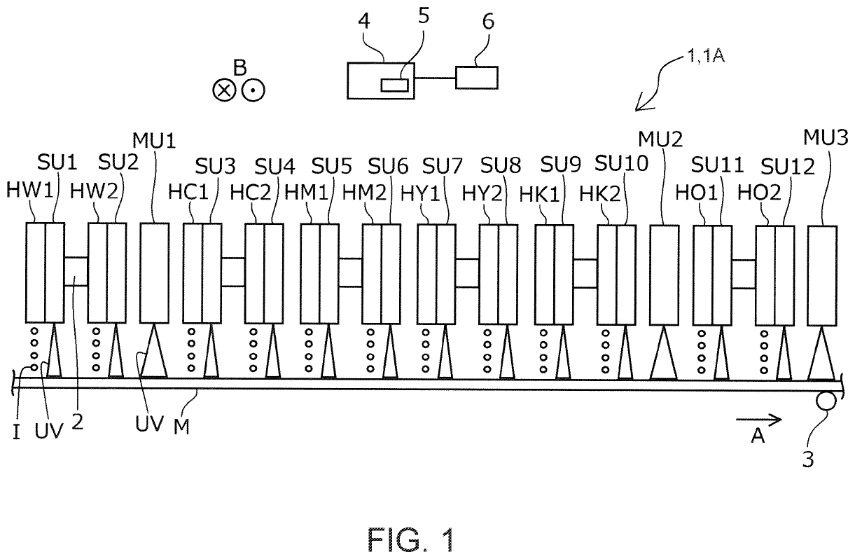

Hereinafter, embodiments according to the present disclosure will be described in detail with reference to the drawings. First, a printing device 1A of a first embodiment as an example of the printing device 1 of the present disclosure will be described with reference to FIGS. 1 to 3. The printing device 1A of the present embodiment is a printing device that forms a printed product on a print medium M by ejecting ultraviolet curable ink I from a head unit H.

As shown in FIG. 1, the printing device 1A of the present embodiment is provided with a plurality of head units H which eject the ultraviolet curable ink I. Specifically, the printing device 1A includes, for example, head units HW1 and HW2 which eject a white ink used as a base, head units HC1 and HC2 which eject a cyan ink used for image formation, head units HM1 and HM2 which eject a magenta ink used for image formation, head units HY1 and HY2 which eject a yellow ink used for image formation, head units HK1 and HK2 which eject a black ink used for image formation, and head units HO1 and HO2 which eject a clear ink used as an overcoat.

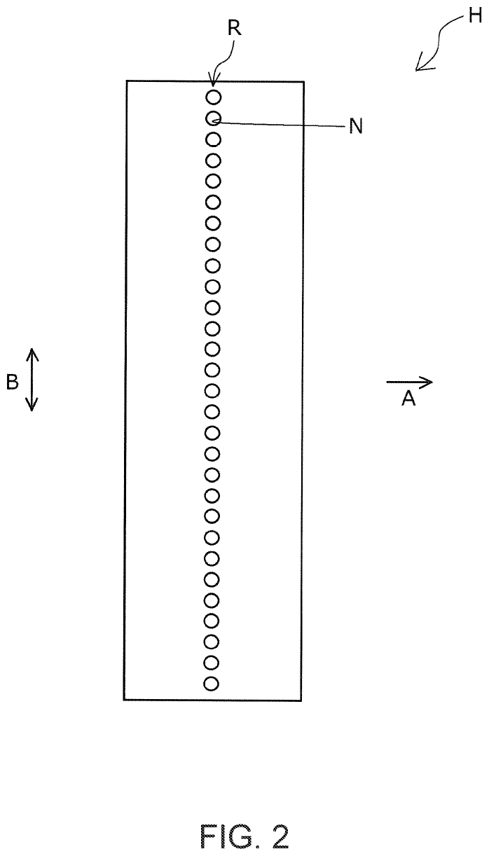

Here, each of the head units H has the same configuration, and specifically, as shown in FIG. 2, each has a nozzle row R in which a plurality of nozzles N are arranged along a width direction B, which is a direction intersecting a transport direction A of the print medium M, and each is configured to eject the ultraviolet curable ink I to the print medium M from the nozzles N based on printing data. Here, the nozzle row R of each head unit H is formed such that the plurality of nozzles N are arranged in the width direction B, which intersects the relative movement direction of the print medium M and the head unit H. That is, each head unit H in the printing device 1A of the present embodiment is a so-called line head.

As shown in FIG. 1, the printing device 1A of the present embodiment is provided with a transport roller 3, which transports the print medium M in the transport direction A with respect to the head unit H as a movement section that relatively moves the print medium M and the head unit H. In the present embodiment, the print medium M is moved with respect to the fixed head unit H, but a configuration in which the print medium M is fixed and the head unit H is moved may be employed.

Actual curing sections MU1, MU2, and MU3 and temporary curing sections SU1, SU2, SU3, SU4, SU5, SU6, SU7, SU8, SU9, SU10, SU11, and SU12 are provided as irradiation sections irradiate the ultraviolet curable ink I that was ejected from the nozzles N of the head unit H and that landed on the print medium M with ultraviolet rays UV and cure the ultraviolet curable ink I. Here, “actual curing” means that the ultraviolet curable ink I that landed on the print medium M is irradiated with ultraviolet rays and a coating film is cured until the form of the printed product is complete and “temporary curing” means that the ultraviolet curable ink I that landed on the print medium M is irradiated with ultraviolet rays, but the coating film is cured only to the extent that the curing degree of the coating film is lower than actual curing. The printing device 1A further includes an operation section 6 that receives instruction from a user and a control section 4 including a storage section 5 that stores various kinds of information and can store new information.

Here, the printing device 1A of the present embodiment has, as the nozzle row R, a first nozzle row R1 which ejects a first ink of a first color as the ultraviolet curable ink I, and a second nozzle row R2 which ejects a second ink of the first color as the ultraviolet curable ink I having characteristics different from those of the first ink. Specifically, the nozzle row R of the head unit HW1 is the first nozzle row R1, and the nozzle row R of the head unit HW2 is the second nozzle row R2, and the white ink ejected from the head unit HW1 and the white ink ejected from the head unit HW2 have the same white color but have different characteristics.

Similarly, the nozzle row R of the head unit HC1 is the first nozzle row R1, the nozzle row R of the head unit HC2 is the second nozzle row R2, and the cyan ink ejected from the head unit HC1 and the cyan ink ejected from the head unit HC2 have the same cyan color but have different characteristics. The nozzle row R of the head unit HM1 is the first nozzle row R1, the nozzle row R of the head unit HM2 is the second nozzle row R2, and the magenta ink ejected from the head unit HM1 and the magenta ink ejected from the head unit HM2 have the same magenta color but have different characteristics.

The nozzle row R of the head unit HY1 is the first nozzle row R1, the nozzle row R of the head unit HY2 is the second nozzle row R2, and the yellow ink ejected from the head unit HY1 and the yellow ink ejected from the head unit HY2 have the same yellow color but have different characteristics. The nozzle row R of the head unit HK1 is the first nozzle row R1, the nozzle row R of the head unit HK2 is the second nozzle row R2, and the black ink ejected from the head unit HK1 and the black ink ejected from the head unit HK2 have the same black color but have different characteristics. Further, the nozzle row R of the head unit HO1 is the first nozzle row R1, the nozzle row R of the head unit HO2 is the second nozzle row R2, and the clear ink ejected from the head unit HO1 and the clear ink ejected from the head unit HO2 have the same transparent color but have different characteristics.

In any combination of the above described ultraviolet curable inks I of the same color, the first ink has a characteristic of easily wet-spreading on the print medium M and the coating film formed on the print medium M is soft and easily expanded and contracted, and the second ink has a characteristic of making the coating film formed on the print medium M robust and hard. Here, the first ink and the second ink are the same color, but the same color here means that they may be treated as inks of the same color, for example, both are used as black inks, and it does not mean that the colors need not be completely the same.

In the printing device 1A of the present embodiment, the plurality of print modes are stored in the storage section 5. Specifically, there are stored a print mode in which emphasis is placed on stretchability in which the coating film follows the printed product without cracking when the printed product is expanded or contracted, a print mode in which emphasis is placed on not causing streaks or blurring during solid printing, a print mode in which emphasis is placed on wet-spreading with respect to the print medium M, a print mode in which emphasis is placed on adhesiveness of the coating film with respect to the print medium M, a print mode in which emphasis is placed on weather resistance of the coating film, a print mode in which emphasis is placed on sharpness of thin lines in the printed product, a print mode in which emphasis is placed on suppression of sticking of the coating film when the printed product is stacked, and a print mode in which emphasis is placed on abrasion resistance of the coating film. In these print modes, the ratio between the print duty of the first ink and the print duty of the second ink is different. It should be noted that “solid printing” means printing in which ink is uniformly applied to a predetermined region without any gaps.

Specifically, in a print mode in which emphasis is placed on stretchability in which the coating film follows the printed product without cracking when the printed product is expanded or contracted, the print duty of the first ink is set to 85% and the print duty of the second ink is set to 15%. The main purpose of this ratio is to emphasize the flexibility of the coating film at the interface with the print medium M. In a print mode in which emphasis is placed on not causing streaks or blurring during solid printing, the print duty of the first ink is set to 100% and the print duty of the second ink is set to 0%. The main purpose of this ratio is to emphasize the wet-spreadability of the coating film at the interface with the print medium M. In a print mode in which emphasis is placed on wet-spreading with respect to the print medium M, the print duty of the first ink is set to 90% and the print duty of the second ink is set to 10%. The main purpose of this ratio is to emphasize the wet-spreadability of the coating film at the interface with the print medium M. In a print mode in which emphasis is placed on adhesiveness of the coating film with respect to the print medium M, the print duty of the first ink is set to 75% and the print duty of the second ink is set to 25%. The main purpose of this ratio is to emphasize the flexibility of the coating film at the interface with the print medium M. In a print mode in which emphasis is placed on weather resistance of the coating film, the print duty of the first ink is set to 50% and the print duty of the second ink is set to 50%. The main purpose of this ratio is to emphasize the flexibility of the inside of the coating film and to make the surface of a coating film surface robust and hard.

In a print mode in which emphasis is placed on sharpness of thin lines in the printed product, the first ink and the second ink are exchanged, the ultraviolet curable ink I ejected first to the print medium M is made to be an ink having characteristics such that the coating film formed on the print medium M is robust and hard, the ultraviolet curable ink I ejected later to the print medium M can easily wet-spread over the print medium M, and made to be an ink having characteristics such that the coating film formed on the print medium M is soft and easily expanded and contracted, the print duty of the ultraviolet curable ink I discharged first to the print medium M is 75% and the print duty of the ultraviolet curable ink I discharged later to the print medium M is 25%. The main purpose of this eject order and this ratio is to suppress the coating film from excessively wet-spreading at the interface with the print medium M and bleeding. In a print mode in which emphasis is placed on suppression of sticking of the coating film when the printed product is stacked, the print duty of the first ink is set to 25% and the print duty of the second ink is set to 75%. The main purpose of this ratio is to make the coating film surface robust and hard. In a print mode in which emphasis is placed on abrasion resistance of the coating film, the print duty of the first ink is set to 10% and the print duty of the second ink is set to 90%. The main purpose of this ratio is to make the coating film surface robust and hard.

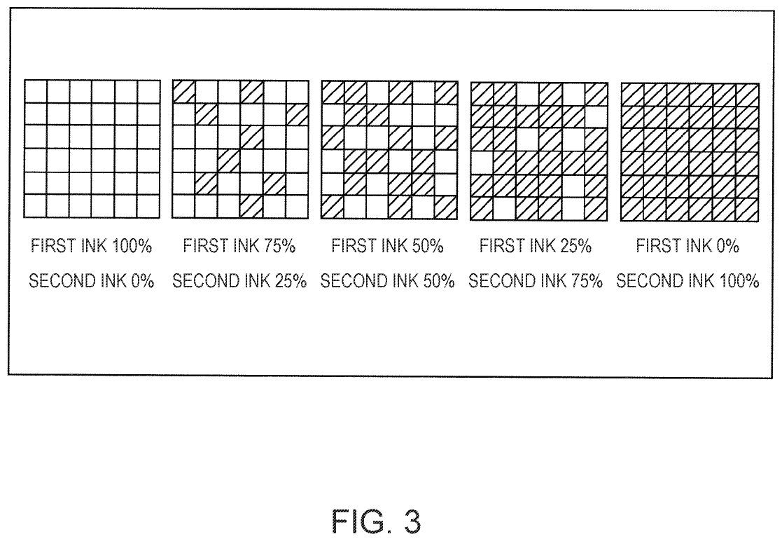

FIG. 3 shows an example of a pixel image when the ratio between the print duty of the first ink and the print duty of the second ink is varied. In other words, FIG. 3 is a drawing showing a specific example of how the first ink and the second ink are distributed to the print data of one pixel by using the printing device 1. In FIG. 3, the corresponding region of the first ink is shown by white, and the corresponding region of the second ink is shown by hatching. In the present embodiment, one pixel of the print data is constituted of a total of 36 ink droplets, six in each of the transport direction A and the width direction B. FIG. 3 shows a specific example when the print duty of the first ink is 100% and the print duty of the second ink is 0%, a specific example when the print duty of the first ink is 75% and the print duty of the second ink is 25%, a specific example when the print duty of the first ink is 50% and the print duty of the second ink is 50%, a specific example when the print duty of the first ink is 25% and the print duty of the second ink is 75%, and a specific example when the print duty of the first ink is 0% and the print duty of the second ink is 100%. However, the method of distributing the first ink and the second ink is not particularly limited, and the first ink and the second ink may be distributed in an arrangement different from those in FIG. 3.

The user can select at least one print mode, that is, the selected print mode from the plurality of print modes via the operation section 6. Then, in each color, the control section 4 forms the printed product at the ratio of the print duty of the first ink and the print duty of the second ink based on the selected print mode. In other words, when the print data includes first color data to be printed using the ultraviolet curable ink I of the first color, the control section 4 distributes the first color data into the first ink and the second ink based on the ratio of the selected print mode and then prints.

In this way, since the printing device 1A of the embodiment enables selection of the selected print mode according to use, it is possible to form the printed product by using the first ink and the second ink of the same color and different characteristics as the ultraviolet curable ink I in a desired ratio. Therefore, the printing device 1A of the present embodiment can form the printed product by using the ultraviolet curable ink I according to the use.

The printing device 1A of the present embodiment is configured such that the plurality of selected print modes can be selected via the operation section 6. Specifically, for example, as the selecting print mode, it is possible to select two print modes, that is, a print mode in which emphasis is placed on stretchability in which the coating film follows the printed product without cracking when the printed product is expanded or contracted, and a print mode in which emphasis is placed on adhesiveness of the coating film with respect to the print medium M. When a plurality of selected print modes are selected, the control section 4 averages the ratio of each selected print mode and the control section is configured to, when the print data includes first color data to be printed using the ultraviolet curable ink I of the first color, distribute the first color data into the first ink and the second ink based on the averaged average ratio and then print. Therefore, the printing device 1A of the present embodiment can form the printed product under conditions that are finely optimized in accordance with various applications, for example, when there are a plurality of priority characteristics.

Specifically, for example, when two print modes are selected as the selected print mode, that is, a print mode in which emphasis is placed on stretchability in which the coating film follows the printed product without cracking when the printed product is expanded or contracted, and a print mode in which emphasis is placed on adhesiveness of the coating film with respect to the print medium M the print duty of the first ink is set to (85%+75%)/2=80%, and the print duty of the second ink is set to (15%+25%)/2=20%. For example, when two print modes are selected as the selected print mode, that is, a print mode in which emphasis is placed on not causing streaks or blurring during solid printing and a print mode in which emphasis is placed on wet-spreading with respect to the print medium M the print duty of the first ink is (100%+90%)/2=95%, and the print duty of the second ink is (0%+10%)/2=5%. Further, for example, when two print modes, that is, a print mode in which emphasis is placed on suppression of sticking of the coating film when the printed product is stacked and a print mode in which emphasis is placed on abrasion resistance of the coating film are selected, the print duty of the first ink is set to (25%+10%)/2=17.5% and the print duty of the second ink is set to (75%+90%)/82.5=5%. In this way, the printing device 1A of the present embodiment is configured to be able to select a plurality of selected print modes but may be configured to be able to select only one selected print mode by subdividing the print mode in advance.

In the above described configuration, the ultraviolet curable ink I of any of the same colors has a characteristic that the first ink has a characteristic of easily wet-spreading on the print medium M and the coating film formed on the print medium M is soft and easily expanded and contracted, and the second ink has a characteristic of making the coating film formed on the print medium M robust and hard. That is, in the printing device 1A of the present embodiment, it can be said that the first nozzle row R1 that ejects the first ink has an arrangement in which the first ink is ejected to the print medium M before the second ink when printing is performed using the ultraviolet curable ink I of the first color with respect to the second nozzle row R2 that ejects the second ink and that the first ink has higher wettability with respect to the print medium M than the second ink. By depositing the first ink, which has higher wettability, to the print medium M before the second ink, the adhesiveness of the coating film formed on the printed product, the solid uniformity of the coating film, and the like are improved. Therefore, with such a configuration, it is possible to form a printed product suitable for a wide range of applications.

As described above, the printing device 1A of the present embodiment includes, as ultraviolet irradiation sections, the actual curing section MU (the actual curing sections MU1, MU2, and MU3), which performs the actual curing by irradiating the ultraviolet rays UV to the ultraviolet curable ink I that was ejected from the nozzles N and that landed on the print medium M, and the temporary curing section SU (the temporary curing sections SU1, SU2, SU3, SU4, US5, US6, US7, US8, US9, US10, US11, and US12), which performs the temporary curing of which the curing degree is lower than the actual curing by irradiating the ultraviolet rays UV to the ultraviolet curable ink I that was ejected from the nozzles N and that landed on the print medium M. Also, each of the head units H is a line head in which the plurality of nozzles N in the nozzle row R of each are arranged in the width direction B and, for example, when printing is performed using the ultraviolet curable ink I of white color as the first color, the head unit HW1 having the first nozzle row R1 which ejects the first ink, the temporary curing section SU1 as the first temporary curing section, the head unit HW2 having the second nozzle row R2 which ejects the second ink, and the temporary curing section SU2 as the second temporary curing section are disposed in this order, which is the order in which the print medium M faces them in the transport direction A.

Similarly, when printing is performed using the ultraviolet curable ink I of cyan color as the first color, the head unit HC1 having the first nozzle row R1 which ejects the first ink, the temporary curing section SU3 as the first temporary curing section, the head unit HC2 having the second nozzle row R2 which ejects the second ink, and the temporary curing section SU4 as the second temporary curing section are disposed in this order, which is the order in which the print medium M faces them in the transport direction A. When printing is performed using the ultraviolet curable ink I of magenta color as the first color, the head unit HM1 having the first nozzle row R1 which ejects the first ink, the temporary curing section SU5 as the first temporary curing section, the head unit HM2 having the second nozzle row R2 which ejects the second ink, and the temporary curing section SU6 as the second temporary curing section are disposed in this order, which is the order in which the print medium M faces them in the transport direction A. When printing is performed using the ultraviolet curable ink I of yellow color as the first color, the head unit HY1 having the first nozzle row R1 which ejects the first ink, the temporary curing section SU7 as the first temporary curing section, the head unit HY2 having the second nozzle row R2 which ejects the second ink, and the temporary curing section SU8 as the second temporary curing section are disposed in this order, which is the order in which the print medium M faces them in the transport direction A.

When printing is performed using the ultraviolet curable ink I of black color as the first color, the head unit HK1 having the first nozzle row R1 which ejects the first ink, the temporary curing section SU9 as the first temporary curing section, the head unit HK2 having the second nozzle row R2 which ejecting the second ink, and the temporary curing section SU10 as the second temporary curing section are disposed in this order, which is the order in which the print medium M faces them in the transport direction A. When printing is performed using the ultraviolet curable ink I of transparent color as the first color, the head unit HO1 having the first nozzle row R1 which ejects the first ink, the temporary curing section SU11 as the first temporary curing section, the head unit HO2 having the second nozzle row R2 which ejects the second ink, and the temporary curing section SU12 as the second temporary curing section are disposed in this order, which is the order in which the print medium M faces them in the transport direction A.

As described above, by using the so-called line head having a nozzle row R in which a plurality of nozzles N are arranged in the width direction B, the first ink is ejected from the first nozzle row R1 to the print medium M and then immediately temporarily cured by the first temporary curing section, and the second ink is ejected from the second nozzle row R2 to the print medium M and then immediately temporarily cured by the ultraviolet curable ink in the second temporary curing section, so that it is possible to suppress a decrease in printing quality of a thin line or the like by spread of the ultraviolet curable ink I to the print medium M due to delay of temporary curing.

Note that, as shown in FIG. 1, the printing device 1A of the present embodiment includes a distance adjustment section 2 which adjusts distance in a direction along the transport direction A between the head unit H having the first nozzle row R1 and the head unit H having the second nozzle row R2, which ejects the second ink. For this reason, it is possible to adjust the distance in the direction along the transport direction A between the head unit H having the first nozzle row R1 and the head unit H having the second nozzle row R2 which ejects the second ink according to the type of the print medium M which is used, the characteristics which are required for the user, or the like. However, a configuration in which such the distance adjustment section 2 is not provided may be adopted.

### Second Embodiment

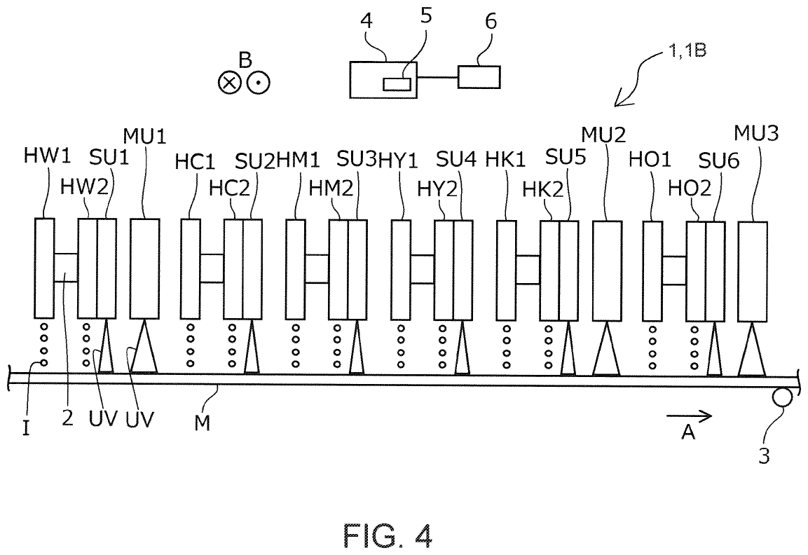

Next, a printing device 1B according to a second embodiment will be described with reference to FIG. 4. FIG. 4 is a drawing corresponding to FIG. 1 in the printing device 1A of the first embodiment. In FIG. 4, components common to those of the first embodiment are denoted by the same reference symbols, and a detailed description thereof will be omitted. Here, the printing device 1B of the present embodiment has the same configuration as the printing device 1A of the first embodiment, except for the configuration of the portions described below. For this reason, the printing device 1B of the present embodiment has the same features as those of the printing device 1A of first embodiment, except for the portions described below.

As shown in FIG. 4, similarly to the printing device 1A of the first embodiment, the printing device 1B of the present embodiment also includes, as the ultraviolet irradiation section, the actual curing section MU that performs actual curing by irradiating ultraviolet rays UV to the ultraviolet curable ink I that was ejected from the nozzles N and that landed on the print medium M, and the temporary curing section SU that performs temporary curing of which the curing degree is lower than the actual curing by irradiating the ultraviolet rays UV to the ultraviolet curable ink I that was ejected from the nozzles N and that landed on the print medium M. Each of the head units H has the same configuration as the head unit H shown in FIG. 2, and is a line head in which each nozzle row R is formed from a plurality of nozzles N arranged in the width direction B. However, the printing device 1B of the embodiment does not include the temporary curing section SU on the upstream side of the head unit H having the second nozzle row R2 in the transport direction A and on the downstream side of the head unit H having the first nozzle row R1 in the transport direction A.

In other words, in the printing device 1B of the present embodiment, for example, when printing is performed using the ultraviolet curable ink I of white color as the first color, the head unit HW1 having the first nozzle row R1 which ejects the first ink, the head unit HW2 having the second nozzle row R2 which ejects the second ink, and the temporary curing section SU1 are disposed in this order, which is the order in which the print medium M faces them in the transport direction A. Similarly, when printing is performed using the ultraviolet curable ink I of cyan color as the first color, the head unit HC1 having the first nozzle row R1 which ejects the first ink, the head unit HC2 having the second nozzle row R2 which ejects the second ink, and the temporary curing section SU2 are disposed in this order, which is the order in which the print medium M faces them in the transport direction A. When printing is performed using the ultraviolet curable ink I of magenta color as the first color, the head unit HM1 having the first nozzle row R1 which ejects the first ink, the head unit HM2 having the second nozzle row R2 which ejects the second ink, and the temporary curing section SU3 are disposed in this order, which is the order in which the print medium M faces them in the transport direction A.

When printing is performed using the ultraviolet curable ink I of yellow color as the first color, the head unit HY1 having the first nozzle row R1 which ejects the first ink, the head unit HY2 having the second nozzle row R2 which ejects the second ink, and the temporary curing section SU4 are disposed in this order, which is the order in which the print medium M faces them in the transport direction A. When printing is performed using the ultraviolet curable ink I of black color as the first color, the head unit HK1 having the first nozzle row R1 which ejects the first ink, the head unit HK2 having the second nozzle row R2 which ejects the second ink, and the temporary curing section SU5 are disposed in this order, which is the order in which the print medium M faces them in the transport direction A. When printing is performed using the ultraviolet curable ink I of the transparent color as the first color, the head unit HO1 having the first nozzle row R1 which ejects the first ink, the head unit HO2 having the second nozzle row R2 which ejects the second ink, and the temporary curing section SU6 are disposed in this order, which is the order in which the print medium M faces them in the transport direction A.

As described above, the printing device 1B according to the present embodiment, it is possible to use the so-called line head having the nozzle row R in which the plurality of nozzles N are arranged in the width direction B to eject the first ink from the first nozzle row R1 to the print medium M, further to eject the second ink from the second nozzle row R2 to the print medium M, and then to temporarily cure the ultraviolet curable ink I by the temporary curing section SU. With such a configuration, it is possible to suppress a decrease in the solid uniformity of the coating film due to the ultraviolet curable ink I being temporarily cured before sufficiently spreading on the print medium M due to the timing of the temporary curing being too early.

To explain from another viewpoint, in the printing device 1 of the first and second embodiments, for example, when printing is performed using the ultraviolet curable ink I of white color as the first color, the head unit HW1 having the first nozzle row R1 which ejects the first ink, the head unit HW2 having the second nozzle row R2 which ejects the second ink, and the actual curing section MU1 are disposed in this order, which is the order in which the print medium M faces them in the transport direction A. Similarly, when printing is performed using the ultraviolet curable ink I of cyan color as the first color, the head unit HC1 having the first nozzle row R1 which ejects the first ink, the head unit HC2 having the second nozzle row R2 which ejects the second ink, and the actual curing section MU2 are disposed in this order, which is the order in which the print medium M faces them in the transport direction A. When printing is performed using the ultraviolet curable ink I of magenta color as the first color, the head unit HM1 having the first nozzle row R1 which ejects the first ink, the head unit HM2 having the second nozzle row R2 which ejects the second ink, and the actual curing section MU3 are disposed in this order, which is the order in which the print medium M faces them in the transport direction A.

When printing is performed using the ultraviolet curable ink I of yellow as the first color, a head unit HY1 having the first nozzle row R1 which ejects the first ink, the head unit HY2 having the second nozzle row R2 which ejects the second ink, and the actual curing section MU4 are disposed in this order, which is the order in which the print medium M faces them in the transport direction A. When the printing is performed using the ultraviolet curable ink I of black color as the first color, the head unit HK1 having the first nozzle row R1 which ejects the first ink, the head unit HK2 having the second nozzle row R2 which ejects the second ink, and the actual curing section MU5 are disposed in this order, which is the order in which the print medium M faces them in the transport direction A. In addition, when printing is performed using the ultraviolet curable ink I of transparent color as the first color, the head unit HO1 having the first nozzle row R1 which ejects the first ink, the head unit HO2 having the second nozzle row R2 which ejects the second ink, and the actual curing section MU6 are disposed in this order, which is the order in which the print medium M faces them in the transport direction A.

As described above, the printing devices 1 according to the first and second embodiments use a so-called line head having the nozzle row R in which a plurality of nozzles N are arranged in the width direction B to eject the first ink from the first nozzle row R1 to the print medium M, eject the second ink from the second nozzle row R2 to the print medium M, and then perform actual curing the ultraviolet curable ink I in the actual curing section MU. With such a configuration, it is possible to simplify the device configuration by eliminating the temporary curing section SU or reducing the number of the temporary curing sections SU, and it is possible to lengthen the time from when the ultraviolet curable ink I deposits to the print medium M to when the ultraviolet rays are irradiated, and it is possible to suppress a decrease in the solid uniformity of the coating film due to the ultraviolet curable ink I being actually cured before sufficiently spreading on the print medium M.

### Third Embodiment

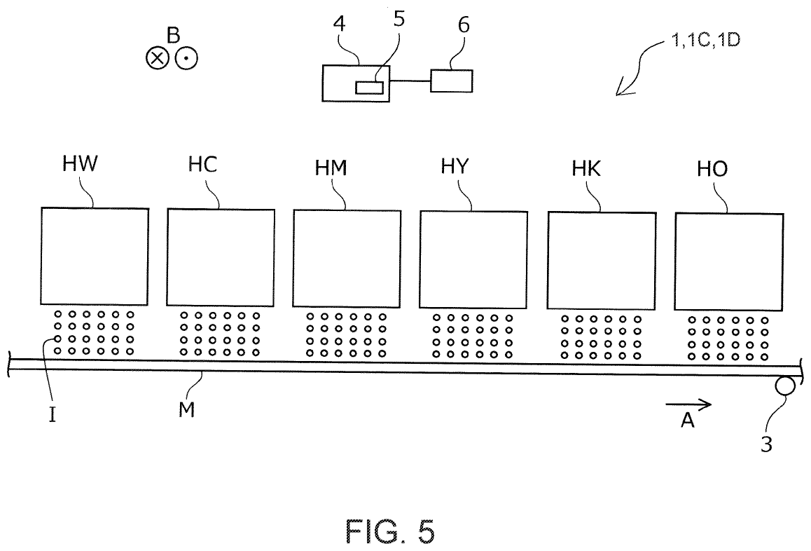

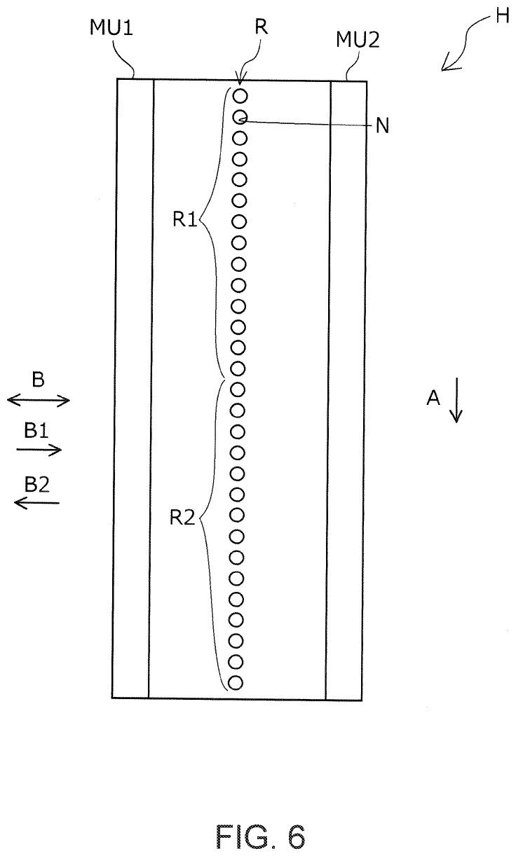

Next, a printing device 1C according to a third embodiment will be described with reference to FIGS. 5 and 6. FIG. 5 is a drawing corresponding to FIG. 1 in the printing device 1 of the first embodiment, and FIG. 6 is a drawing corresponding to FIG. 2 in the printing device 1 of the first embodiment. In FIGS. 5 and 6, components common to those of the first embodiment and the second embodiment are denoted by the same reference symbols, and a detailed description thereof will be omitted. Here, the printing device 1C of the present embodiment has the same configuration as the printing device 1 of the first embodiment and the second embodiment, except for the configuration of the portions described below. For this reason, the printing device 1C of the present embodiment has the same features as those of the printing device 1 of the first embodiment and the second embodiment, except for the parts described below.

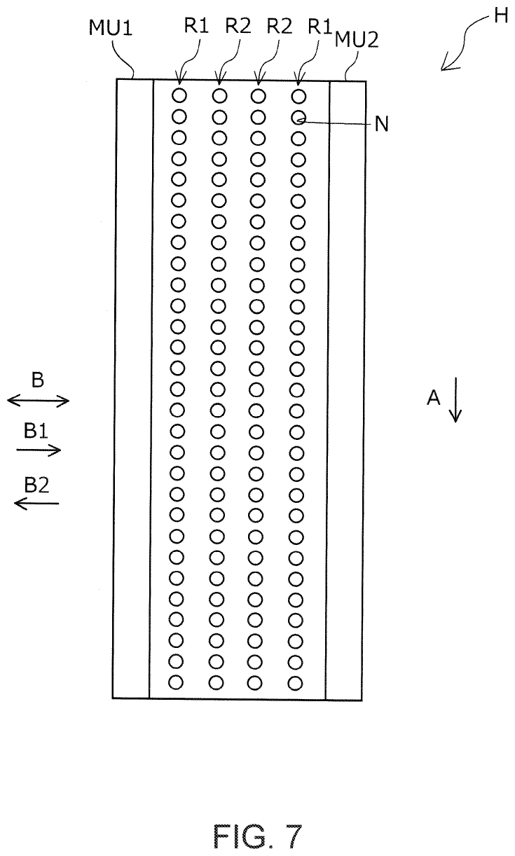

As described above, the printing device 1 of the first embodiment and the second embodiment include, as the head unit H, the so-called line head having the nozzle row R in which the plurality of nozzles N are arranged in the width direction B. On the other hand, the printing device 1D of the present embodiment shown in FIGS. 5 and 6 includes, as the head unit H, a so-called serial head that has the nozzle row R in which the plurality of nozzles N are arranged along the transport direction A as shown in FIG. 7 and that can reciprocally move in a forward direction B1 and a return direction B2 along the width direction B. Printing is executed by ejecting the ultraviolet curable ink I from desired nozzles N while continuously moving the print medium M in the transport direction A in the printing device 1 including the line head as in the printing devices 1 of the first embodiment and the second embodiment. On the other hand, in the printing device 1 including the serial head such as the printing device 1C of the present embodiment, printing is executed by ejecting the ultraviolet curable ink I from a desired nozzle N while intermittently moving the print medium M in the transport direction A and moving the head unit H in the width direction B at a timing during stoppage at that time.

In detail, in the printing device 1C of the present embodiment, as shown in FIG. 6, each of the nozzle rows R of the first nozzle row R1 which ejects the first ink and the second nozzle row R2 which ejects the second ink are arranged the plurality of nozzles N along the transport direction A. In addition, the first nozzle row R1 and the second nozzle row R2 are arranged in series in the transport direction A, and in order of the forward direction B1 in the width direction B, the actual curing section MU1 as the irradiation section of the ultraviolet rays UV, the first nozzle row R1 and the second nozzle row R2, and the actual curing section MU2 as the irradiation section of the ultraviolet rays UV are disposed. The actual curing section MU2, the first nozzle row R1, the second nozzle row R2, and the actual curing section MU1 are disposed in this order in the return direction B2 in the width direction B. That is, both in the order of the forward direction B1 and in the order of the return direction B2, the actual curing section MU, the first nozzle row R1 and the second nozzle row R2, and the actual curing section MU are disposed in this order.

More specifically, as shown in FIG. 5, the printing device 1C of the present embodiment includes, as the head units H, the head unit HW capable of ejecting the ultraviolet curable ink I of white color, the head unit HC capable of ejecting the ultraviolet curable ink I of cyan color, the head unit HM capable of ejecting the ultraviolet curable ink I of magenta color, the head unit HY capable of ejecting the ultraviolet curable ink I of yellow color, the head unit HK capable of ejecting the ultraviolet curable ink I of black color, and the head unit HO capable of ejecting the ultraviolet curable ink I of transparent color. In addition, each of the head unit HW, the head unit HC, the head unit HM, the head unit HY, the head unit HK, and the head unit HO are disposed the forward direction B1 in the order of the actual curing section MU1 as the irradiation section of the ultraviolet rays UV, the first nozzle row R1 and the second nozzle row R2, and the actual curing section MU2 as the irradiation section of the ultraviolet rays UV.

As described above, the printing device 1C according to the present embodiment, it is possible to use the head unit H shown in FIG. 6, which is a serial head to, for each reciprocating movement of the head unit H, eject the first ink from the first nozzle row R1 to the print medium M, to cure the ultraviolet curable ink I by the actual curing section MU1, then to move the print medium M and the head unit H relative to each other to change the pass, further to eject the second ink from the second nozzle row R2 to the print medium M, and then to cure the ultraviolet curable ink I by the actual curing section MU2. With such a configuration, the number of nozzle rows R to be formed can be reduced and the head unit H can be reduced in size. It is possible to suppress a decrease in printing quality of a thin line or the like due to excessive spreading of the ultraviolet curable ink I on the print medium M due to a delay in irradiation of ultraviolet rays UV.

### Fourth Embodiment

Next, a printing device 1D according to a fourth embodiment will be described with reference to FIGS. 5 and 7. Here, FIG. 5 is a drawing showing the printing device 1C of the third embodiment as described above, and can also be regarded as a drawing showing the printing device 1D of the present embodiment, which has the same configuration as that of the printing device 1C of the third embodiment, except for the configuration of the head unit H. FIG. 7 is a drawing corresponding to FIG. 2 in the printing device 1 of the first embodiment. In FIG. 7, components common to those of the first embodiment to the third embodiment are denoted by the same reference symbols, and a detailed description thereof will be omitted. Here, the printing device 1D of the present embodiment has the same configuration as the printing device 1 of the first embodiment to the third embodiment, except for the configuration of the portions described below. For this reason, the printing device 1D of the present embodiment has the same features as those of the printing device 1 of the first embodiment to the third embodiment, except for the portions described below.

As shown in FIG. 7, similarly to the printing device 1D of the third embodiment shown in FIG. 6, the printing device 1C of the present embodiment includes, as the head unit H, the so-called serial head which has a nozzle row R formed by arranging a plurality of nozzles N along the transport direction A and capable of reciprocating movement in the forward direction B1 and the return direction B2 along the width direction B. In detail, the head unit H of the printing device 1D of the present embodiment is configured capable of reciprocating movement in the width direction B, and as shown in FIG. 7, each of the nozzle rows R is formed by arranging a plurality of nozzles N along the transport direction A, and the first nozzle row R1 and the second nozzle row R2 are arranged in parallel in the width direction B. In addition, the actual curing section MU1 as the irradiation section of the ultraviolet rays UV, the first nozzle row R1, the second nozzle row R2, the second nozzle row R2, the first nozzle row R1, and the actual curing section MU2 as the irradiation section of the ultraviolet rays UV are disposed in this order in the forward direction B1 of the width direction B. Note that the actual curing section MU2, the first nozzle row R1, the second nozzle row R2, the second nozzle row R2, the first nozzle row R1, and the actual curing section MU1 are disposed in this order in the return direction B2 of the width direction B. That is, both in the order of the forward direction B1 and in the order of the return direction B2, the actual curing section MU, the first nozzle row R1, the second nozzle row R2, the second nozzle row R2, the first nozzle row R1, and the actual curing section MU are disposed.

More specifically, as shown in FIG. 5, the printing device 1D of the present embodiment includes, as the head units H, the head unit HW capable of ejecting the ultraviolet curable ink I of white color, the head unit HC capable of ejecting the ultraviolet curable ink I of cyan color, the head unit HM capable of ejecting the ultraviolet curable ink I of magenta color, the head unit HY capable of ejecting the ultraviolet curable ink I of yellow color, the head unit HK capable of ejecting the ultraviolet curable ink I of black color, and the head unit HO capable of ejecting the ultraviolet curable ink I of transparent color. In addition, in each of the head unit HW, the head unit HC, the head unit HM, the head unit HY, the head unit HK, and the head unit HO, the actual curing section MU1 as the irradiation section of the ultraviolet rays UV, the first nozzle row R1, the second nozzle row R2, and the actual curing section MU2 as the irradiation section of the ultraviolet rays UV are disposed in this order in the forward direction B1.

As described above, the printing device 1D according to the present embodiment, it is possible to use the head unit H shown in FIG. 7, which is a serial head, to, for each reciprocal movement of the head unit H, eject the first ink from the first nozzle row R1 to the print medium M, further to eject the second ink from the second nozzle row R2 to the print medium M, to cure the ultraviolet curable ink I by the actual curing section MU1, then to relatively move the print medium M and the head unit H relative to change the pass, to eject the first ink from the first nozzle row R1 to the print medium M, further to eject the second ink from the second nozzle row R2 to the print medium M, and to cure the ultraviolet curable ink by the actual curing section MU2. By adopting such a configuration, it is possible to widen the printing range for one pass, it is possible to increase the printing speed, and it is possible to suppress a decrease in printing quality of a thin line or the like due to excessive spreading of the ultraviolet curable ink I on the print medium M due to a delay in irradiation of ultraviolet rays UV.

### Fifth Embodiment

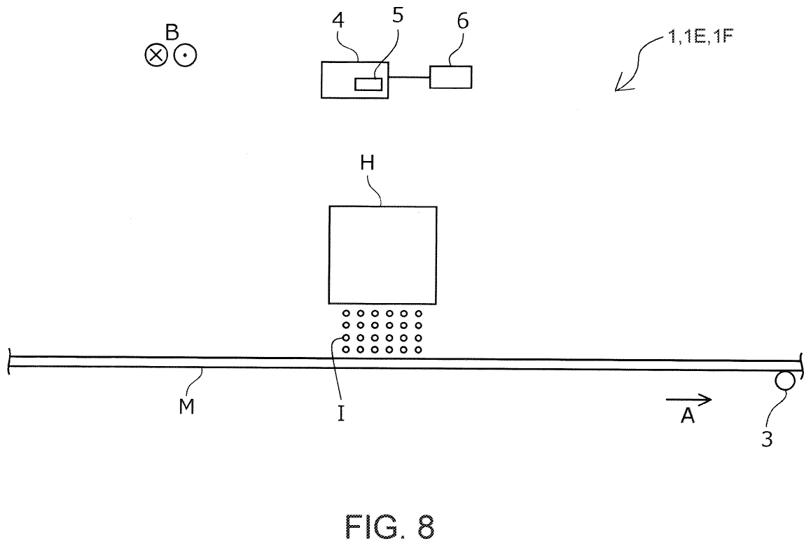

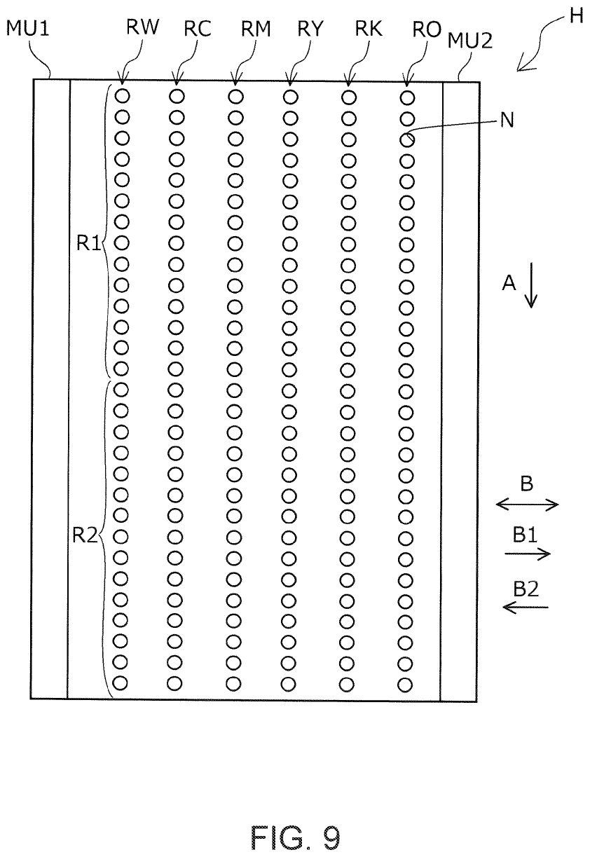

Next, a printing device 1E according to a fifth embodiment will be described with reference to FIGS. 8 and 9. FIG. 8 is a drawing corresponding to FIG. 1 in the printing device 1 of the first embodiment, and FIG. 9 is a drawing corresponding to FIG. 2 in the printing device 1 of the first embodiment. In FIGS. 8 and 9, components common to those of the first embodiment to the fourth embodiment are denoted by the same reference symbols, and a detailed description thereof will be omitted. Here, the printing device 1E of the present embodiment has the same configuration as the printing device 1 of the first embodiment 1 to the fourth embodiment, except for the configuration of the portions described below. For this reason, the printing device 1E of the present embodiment has the same features as those of the printing device 1 of the first embodiment to the fourth embodiment, except for the portions described below.

As described above, the printing device 1 of the first embodiment and the second embodiment include, as the head unit H, the so-called line head having the nozzle row R in which the plurality of nozzles N are arranged in the width direction B. On the other hand, similarly to the printing device 1 of the third embodiment and the fourth embodiment, the printing device 1E of the present embodiment shown in FIGS. 8 and 9 includes, as the head unit H, a so-called serial head that has a nozzle row R in which the plurality of nozzles N are arranged along the transport direction A as shown in FIG. 9 and that is capable of reciprocal movement in the forward direction B1 and the return direction B2 along the width direction B. The printing device 1E of the present embodiment has only one head unit H, and the head unit H is provided with, as nozzle rows R, a nozzle row RW capable of ejecting the ultraviolet curable ink I of white color, a nozzle row RC capable of ejecting the ultraviolet curable ink I of cyan color, a nozzle row RM capable of ejecting the ultraviolet curable ink I of magenta color, a nozzle row RY capable of ejecting the ultraviolet curable ink I of yellow color, a nozzle row RK capable of ejecting the ultraviolet curable ink I of black color, and a nozzle row RO capable of ejecting the ultraviolet curable ink I of transparent color. With such a configuration, it is possible to reduce the number of nozzle rows R to be formed and to reduce the size of the head unit H compared to the configuration of the sixth embodiment (to be described later). It is possible to suppress a decrease in printing quality of a thin line or the like due to excessive spreading of the ultraviolet curable ink I on the print medium M due to a delay in irradiation of ultraviolet rays UV.

### Sixth Embodiment

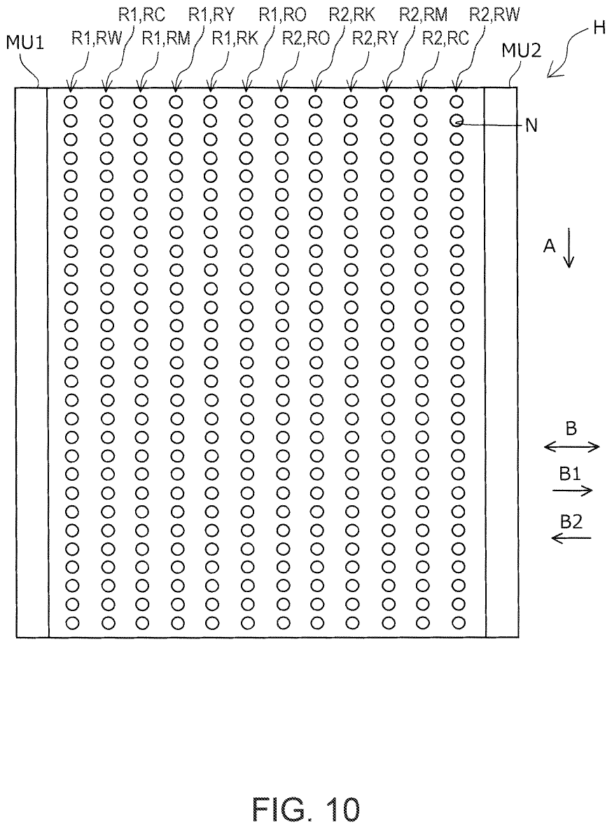

Next, a printing device 1F according to a sixth embodiment will be described with reference to FIGS. 8 and 10. Here, FIG. 8 is a drawing showing the printing device 1E of the fifth embodiment as described above, and can also be regarded as a drawing showing the printing device 1F of the present embodiment having the same configuration as that of the printing device 1E of the fifth embodiment, except for the configuration of the head unit H. FIG. 10 is a drawing corresponding to FIG. 2 in the printing device 1 of the first embodiment. In FIG. 10, components common to those of the first embodiment to the sixth embodiment are denoted by the same reference symbols, and a detailed description thereof will be omitted. Here, the printing device 1F of the present embodiment has the same configuration as the printing device 1 of the first embodiment to the fifth embodiment, except for the configuration of the portions described below. For this reason, the printing device 1F of the present embodiment has the same features as those of the printing device 1 of the first embodiment to the fifth embodiment, except for the portions described below.

As shown in FIG. 8, the printing device 1F of the present embodiment has only one head unit H which is the so-called serial head. As shown in FIG. 10, the head unit H is provided with, as the nozzle rows R, the nozzle row RW capable of ejecting the ultraviolet curable ink I of white color, the nozzle row RC capable of ejecting the ultraviolet curable ink I of cyan color, the nozzle row RM capable of ejecting the ultraviolet curable ink I of magenta color, the nozzle row RY capable of ejecting the ultraviolet curable ink I of yellow color, the nozzle row RK capable of ejecting the ultraviolet curable ink I of black color, and the nozzle row RO capable of ejecting the ultraviolet curable ink I of transparent color. As shown in FIG. 10, two of these nozzle rows R are provided for each color, such as the first nozzle row R1 and the second nozzle row R2. By adopting such a configuration, compared to the configuration of the fifth embodiment, it is possible to widen the printing range for one pass, it is possible to increase the printing speed, and it is possible to suppress a decrease in the printing quality of a thin line or the like due to excessive spreading of the ultraviolet curable ink I on the print medium M due to a delay in irradiation of the ultraviolet rays UV.

The present disclosure is not limited to the above described embodiments, and can be realized by various configurations without departing from the scope of the present disclosure. For example, the technical features in the embodiments corresponding to the technical features in the respective aspects described in the summary of the present disclosure can be appropriately replaced or combined in order to solve some or all of the above described problems or in order to achieve some or all of the above described effects. If the technical features are not described as essential in this specification, the technical features can be appropriately deleted.

What is claimed is:

1. A printing device comprising:
a head unit that has nozzle rows in which a plurality of nozzles are arranged and that is configured to eject an ultraviolet curable ink to a print medium from the nozzles based on print data;
a movement section configured to cause relative movement of the print medium and the head unit;
an irradiation section configured to irradiate ultraviolet rays to cure the ultraviolet curable ink that was ejected from the nozzle and that landed on the print medium;
an operation section;
a storage section; and
a control section, wherein
the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink,
the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row,
the control section is configured to enable selection of at least one selected print mode from among the plurality of print modes via the operation section, and
the control section is configured to, when the print data includes first color data to be printed using the ultraviolet curable ink of the first color, distribute the first color data into the first ink and the second ink based on the ratio of the selected print mode and then print.

2. The printing device according to claim 1, wherein
the control section is configured to enable selection of a plurality of selected print modes via the operation section and
when a plurality of selected print modes are selected, the control section averages the ratios of the selected print modes, and when the print data includes the first color data to be printed using the ultraviolet curable ink of the first color, the control section distributes the first color data into the first ink and the second ink based on the averaged average ratio and then prints.

3. The printing device according to claim 1, wherein
the first nozzle row is disposed such that the first ink is ejected to the print medium before the second ink when printing is performed using the ultraviolet curable ink of the first color with respect to the second nozzle row and
the first ink has higher wettability with respect to the print medium than the second ink.

4. The printing device according to claim 3, wherein
the irradiation section includes an actual curing section configured to perform actual curing by irradiating the ultraviolet curable ink that was ejected from the nozzles and that landed on the print medium with ultraviolet rays, and a temporary curing section configured to perform temporary curing with a lower curing degree than the actual curing by irradiating the ultraviolet curable ink that was ejected from the nozzles and that landed on the print medium with ultraviolet rays,
each of the nozzle rows is formed such that the plurality of nozzles are arranged in a width direction that intersects a relative movement direction of the print medium and the head unit, and
when printing is performed using the ultraviolet curable ink of the first color, the first nozzle row, the first temporary curing section as the temporary curing section, the second nozzle row, and the second temporary curing section as the temporary curing section are disposed in this order, which is the order in which the print medium faces them in the relative movement direction.

5. The printing device according to claim 3, wherein
the irradiation section includes an actual curing section configured to perform actual curing by irradiating the ultraviolet curable ink that was ejected from the nozzles and that landed on the print medium with ultraviolet rays, and a temporary curing section configured to perform temporary curing with a lower curing degree than the actual curing by irradiating the ultraviolet curable ink that was ejected from the nozzles and that landed on the print medium with ultraviolet rays,
each of the nozzle rows is formed such that the plurality of nozzles are arranged in a width direction that intersects a relative movement direction of the print medium and the head unit, and
when printing is performed using the ultraviolet curable ink of the first color, the first nozzle row, the second nozzle row, and the temporary curing section are disposed in this order, which is the order in which the print medium faces them in the relative movement direction.

6. The printing device according to claim 3, wherein
the irradiation section includes an actual curing section configured to perform actual curing by irradiating the ultraviolet curable ink that was ejected from the nozzle and that landed on the print medium with ultraviolet rays,
each of the nozzle rows is formed such that the plurality of nozzles are arranged in a width direction that intersects a relative movement direction of the print medium and the head unit, and
when printing is performed using the ultraviolet curable ink of the first color, the first nozzle row, the second nozzle row, and the actual curing section are disposed in this order, which is the order in which the print medium faces them in the relative movement direction.

7. The printing device according to claim 3, wherein
the head unit is configured to reciprocally move in a width direction that intersects a relative movement direction of the print medium and the head unit,
each of the nozzle rows is formed with the plurality of nozzles that are arranged along the relative movement direction, the first nozzle row and the second nozzle row are arranged in series in the relative movement direction, and
the irradiation section, the first nozzle row and the second nozzle row, and the irradiation section are disposed in order from one side to the other side in the width direction.

8. The printing device according to claim 3, wherein
the head unit is configured to reciprocally move in a width direction that intersects a relative movement direction of the print medium and the head unit,
each of the nozzle rows is formed with the plurality of nozzles that are arranged along the relative movement direction,
the first nozzle row and the second nozzle row are arranged in parallel in the width direction, and
the irradiation section, the first nozzle row, the second nozzle row, the second nozzle row, the first nozzle row, and the irradiation section are disposed in order from one side to the other side in the width direction.

9. A printing method for printing device, the printing device including
a head unit that has nozzle rows in which a plurality of nozzles are arranged and that is configured to eject an ultraviolet curable ink to a print medium from the nozzles based on print data;
a movement section configured to cause relative movement of the print medium and the head unit;
an irradiation section configured to irradiate ultraviolet rays to cure the ultraviolet curable ink that was ejected from the nozzle and that landed on the print medium;
an operation section; and
a storage section, wherein
the printing device has, as the nozzle rows, a first nozzle row configured to eject a first ink of a first color as the ultraviolet curable ink, and a second nozzle row configured to eject a second ink of the first color as the ultraviolet curable ink having characteristics different from those of the first ink,
the storage section is configured to store a plurality of print modes in which printing is performed using the ultraviolet curable ink of the first color, the plurality of print modes having different ratios between a print duty of the first ink ejected from the first nozzle row and a print duty of the second ink ejected from the second nozzle row, and
the control section is configured to enable selection of at least one selected print mode from among the plurality of print modes via the operation section,
the method comprising:
when the print data includes first color data to be printed using the ultraviolet curable ink of the first color, the first color data is distributed into the first ink and the second ink based on the ratio of the selected print mode and then printed.
